(19) United States
(12) Patent Application Publication
(10) Pub. No.: US 2008/0288633 A1
(43) Pub. Date: Nov. 20, 2008

(54) NETWORK DEVICE TRACKING USING A NETWORK DEVICE SERVER

(75) Inventors: Mike Evans, Boise, ID (US); William B. Weiser, Meridian, ID (US); R. Douglas Jones, Boise, ID (US)

Correspondence Address: WORKMAN NYDEGGER, 60 EAST SOUTH TEMPLE, 1000 EAGLE GATE TOWER, SALT LAKE CITY, UT, 84111, US

(73) Assignee: KESTRELINK CORPORATION, Boise, ID (US)

(21) Appl. No.: 11/750,811

(22) Filed: May 18, 2007

(51) Int. Cl. G06F 15/173

(52) U.S. Cl. 709/224

(57) ABSTRACT

Systems and methods for tracking devices that are connected to physical communication ports of a network device server. In one example embodiment, a method includes detecting the connection of a device to a physical communication port of a device server; determining whether the device has been assigned an NCC; if the device has not been assigned an NCC, assigning an unassigned NCC to the device; and mapping the device's assigned NCC to the physical communication port.

### BACKGROUND

Computers are commonly attached to peripheral devices. These peripheral devices can include, for example, storage devices, video capture devices, cd-writers, scanners, and printers. Peripheral devices are typically configured to connect to computers through communication ports, such as USB ports or serial ports. In order for a computer to utilize a peripheral device that is connected to a communication port of the computer, a device driver must be loaded or installed on the computer. A device driver is software that contains instructions that allow the computer to communicate with and control the peripheral device. Generally each distinct model of a peripheral device requires a distinct device driver.

In networked computing environments, it is sometimes useful to make a single peripheral device available to multiple networked computers. For example, it may be useful to make a particular printer available to each computer on a network. By so doing, the printer can be accessed by multiple network users and the resources of the printer can be shared between the users.

In order to make a peripheral device accessible to multiple networked computers, an intermediate connecting device can be employed. For example, a peripheral device can be physically connected to a communication port of the intermediate connecting device, and the intermediate connecting device can in turn be connected to the network. Each networked computer can then connect to the peripheral device through the intermediate connecting device. Each networked computer will designate the peripheral device to which it wishes to connect using a network communication channel (“NCC”) corresponding to the communication port to which the peripheral device is physically connected. The correct device driver for a peripheral device can be loaded or installed on each network computer in order for each computer to communicate with and control the peripheral device. The driver is generally tied to the NCC of the communication port to which the peripheral device is connected.

While employing an intermediate connecting device can enable multiple networked computers to access a single peripheral device across a network, problems can arise as peripheral devices are disconnected and reconnected to different communication ports of the intermediate connecting device. This is because generally there is no explicit notification to the networked computer when a peripheral device is disconnected or reconnected. After the device driver for a particular peripheral device is loaded or installed on a networked computer, the networked computer will continually attempt to communicate with and control the peripheral device through the NCC of the communication port to which the peripheral device was initially connected. If the peripheral device is disconnected from the original communication port and reconnected to a different communication port of the intermediate connecting device, however, the networked computer's attempts to communicate with and control the peripheral device will fail. In addition, if a second peripheral device is connected to the original communication port of the intermediate connecting device, a driver mismatch may occur if the device driver of the first peripheral device is not compatible with the second peripheral device.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention may include systems and methods for tracking devices that are connected to communication ports of a network device server. Current embodiments facilitate communication between a networked computer and a peripheral device even where the peripheral device has been physically disconnected from a first communication port and physically reconnected to a second communication port. Current embodiments also facilitate the sending of a message to the networked computer indicating when a disconnected peripheral device is not currently available for communication. For example, in one embodiment, a method includes detecting the connection of a device to a communication port of a device server; determining whether the device has been assigned a NCC; if the device has not been assigned a NCC, assigning an unassigned NCC to the device; and mapping the device's assigned NCC to the communication port.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are disclosed in the appended drawings. Understanding that these drawings depict only typical embodiments and are not therefore to be considered to be limiting in scope, embodiments will be described and explained with additional specificity and detail through the use of the accompanying drawings in which:

FIG. 1A discloses a schematic representation of an example environment in which example embodiments of the present invention may operate;

FIG. 1B discloses the example network device server of FIG. 1A in greater detail; and

FIG. 2A-2H discloses an example method for tracking devices that are connected to communication ports of a network device server.

### DETAILED DESCRIPTION OF EXAMPLE EMBODIMENTS

As noted above, example embodiments of the invention relate to systems and methods for tracking devices that are connected to communication ports of a network device server. As used herein, the terms “network device server” or “device server” refer to an intermediate computing device positioned between a computer network and one or more peripheral devices. A network device server also has at least one physical communication port with which a peripheral device can be physically connected. Although example embodiments disclosed herein focus mainly on network device servers having multiple communication ports, many of the example methods disclosed herein work equally well with a network device server having a single communication port. For example, a “network device server” can be a plug in card having a single physical communication port configured to physically connect with a peripheral device and also having a wireless network transceiver that is used to facilitate communication between the peripheral device and other computing devices in communication with the wireless network.

### I. Example Network Environment

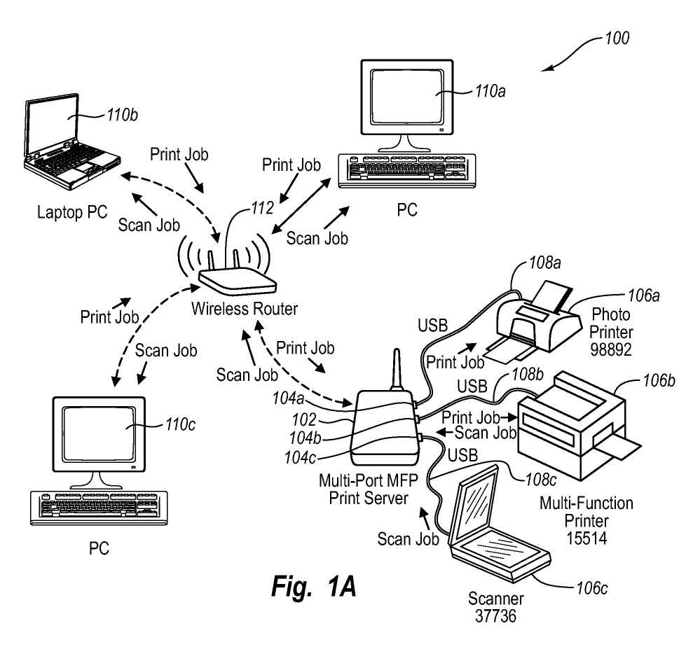

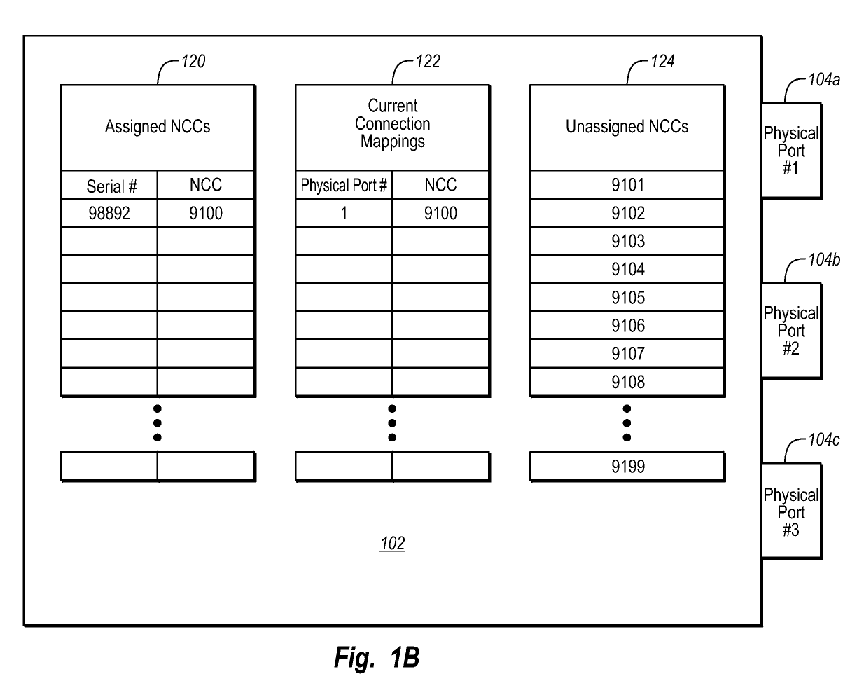

The example methods disclosed herein can be implemented in a network device server that is in communication with a computer network. With reference now to FIG. 1A, a networked computing system 100 is disclosed. System 100 includes a print server 102. The print server 102 is one example of a network device server. The print server 102 is also known as a network printer adapter because it enables printers or other devices with a communications interface to be connected to a wired or a wireless Ethernet network. The print server 102 can be implemented using a KestrelPrint™ Wireless MFP Server-Bridge manufactured by Kestrelink in Boise, Id. The print server 102 can support native Windows printing and scanning across a network. The print server 102 includes a processor. The processor can be, for example, a Ubicom IP3023 network processor manufactured by Ubicom in Sunnyvale, Calif.

The print server 102 includes three physical communication ports 104a-104c, although printer server 102 could include as few as one or more than three physical communication ports. Each of the physical communications ports 104a-104c is configured to facilitate a physical connection between the print server 102 and a peripheral device. Each of the physical communications ports 104a-104c can be, for example, a USB 2.0 Full Speed port or a serial port cable of receiving a USB cable or a serial cable, respectively, of a peripheral device. Other types of ports corresponding to any number of data communication standards are also possible for the physical communications ports 104a-104c.

The system 100 also includes multiple network peripheral devices 106a-106c. As disclosed in FIG. 1A, the peripheral device 106a is a photo printer with a serial number or identification key (“IK”) of “98892”, the peripheral device 106b is a multi-function printer with a serial number of “15514”, and the peripheral device 106c is a scanner with a serial number of “37736”. Other examples of network peripheral devices which could be connected to the printer server 102 include storage devices, video capture devices, cd-writers, other types of printers and scanners, and any other data device that is accessed by one or more networked computers for which a software driver located on each networked computer is required to communicate with the device. Each of the peripheral devices 106a-106c is configured to physically connect to the print server 102 through one of the physical communications ports 104a-104c. As illustrated in FIG. 1A, a USB cable 108a of the printer 106a is physically connected to the USB port 104a, a USB cable 108b of the multi-function printer 106b is physically connected to the USB port 104b, and a USB cable 108c of the scanner 106c is physically connected to the USB port 104c.

Generally, the network print server 102 can be located in a local area network (LAN) that is configured to transmit and receive commands between peripheral devices and computing devices. For example, in one embodiment, the print server 102 may be implemented in a home environment to transmit and receive commands between peripheral devices and computing devices of home users. The connections between the print server 102 and other computing devices in the network may be any suitable network connection including hardwired Ethernet connections, wireless WiFi connections, 802.11b/g including Turbo Mode, or any other suitable connection. As disclosed in FIG. 1A, the print server 102 is in communication with a network of computers 110a-110c. The example network disclosed in FIG. 1A is a wireless WiFi network.

Data, such as print jobs and scan jobs, can be wirelessly communicated between the computers 110a-110c and one or more WiFi-enabled base stations, such as a wireless router 112. The print jobs and scan jobs can then be wirelessly communicated between the wireless router 112 and the print server 102. The print jobs and scan jobs can then be communicated between the print server 102 and the peripheral devices 106a-106c through the physical communication ports 104a-104c and the physical connections 108a-108c, respectively. Thus, the print server 102 can facilitate communication between the networked computers 110-110c and the peripheral devices 106a-106c without the necessity of a direct physical connection between each of the networked computers 110a-110c and each of the peripheral devices 106a-106c.

In order to communicate with a peripheral device, a networked computer must load or install a driver that corresponds to the peripheral device. A device driver is software that contains instructions that allow a computer to communicate with and control a peripheral device. Generally each distinct model of a peripheral device requires the loading or installation of a distinct device driver. Generally, after a peripheral device driver is loaded or installed on a computer, the computer will thereafter attempt to communicate with the peripheral device at a given network communication channel (“NCC”). The NCC can be any type of communication addressing scheme, for example, a raw TCP port address. The term ‘raw TCP port address’ as used herein is defined as a TCP port address that has no other protocol built on that port address. In one alternative embodiment, a non-raw TCP port address could be utilized.

### II. Example Network Device Server

Turning now to FIG. 1B, aspects of the example print server of FIG. 1A are disclosed in greater detail. As disclosed in FIG. 1B, the physical communication ports 104a-104c included as part of the print server 102 are each assigned a unique physical port number. In particular, the USB port 104a is assigned physical port number “1” the USB port 104b is assigned physical port number “2” and the USB port 104c is assigned physical port number “3”. The print server 102 also includes an assigned NCC table 120, a current connection address mappings table 122, and an unassigned NCC table 124. As disclosed in FIG. 1B, each of the tables 120-124 can expand or shrink as records are inserted into the table or deleted from the table. The tables 120-124 can be any type of data storage containers to which the print server 102 has access. For example, the tables 120-124 can be included in a flat file format, a comma separated list, or in a relational database. The tables 120-124 can physically reside on the printer server or on another computing device with which the print server 102 can electronically communicate.

The print server 102 can use the assigned NCC table 120 to assign a NCC to an IK of one of the peripheral devices 106a-106c. An IK can be any data that uniquely identifies one peripheral device over another. In one alternative embodiment, an IK can be any data that uniquely identifies a particular model of a peripheral device. In a second alternative embodiment, an IK can be any data that uniquely identifies all peripheral devices that are compatible with a particular device driver. For example, an IK can be a serial number, or a combination of a serial number and a model number, of a peripheral device. The print server 102 can use the current connection mappings table 122 to map one of the physical communication ports 104a-104c to an NCC assigned to one of the peripheral devices 106a-106c. The print server 102 can use the unassigned NCC table 124 to maintain a list of all available NCCs that are not currently assigned to one of the peripheral devices 106a-106c. The available NCCs can be, for example, raw TCP port addresses. In one embodiment, the initial pool of unassigned raw TCP port addresses may include only addresses “9100” to ”.“9199”. In other embodiments, the initial pool of unassigned raw TCP port addresses may includes a greater or lesser number of raw TCP port addresses. The tables 120-124, therefore, enable the print server 102 to maintain and store a device connection history in non-volatile memory to enable the tracking of peripheral devices.

### III. Example Method For Tracking Devices

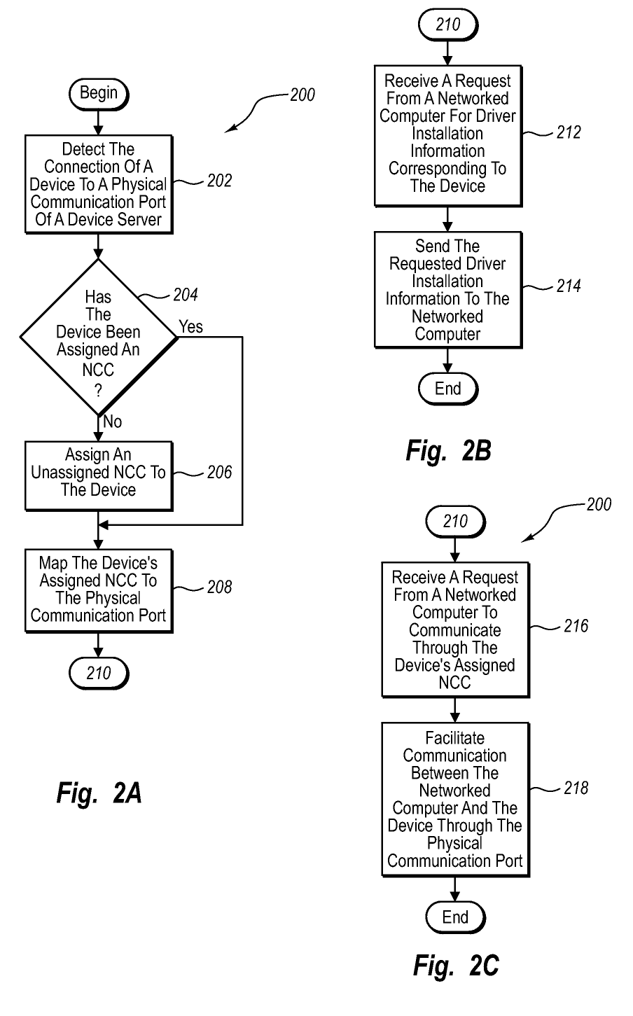

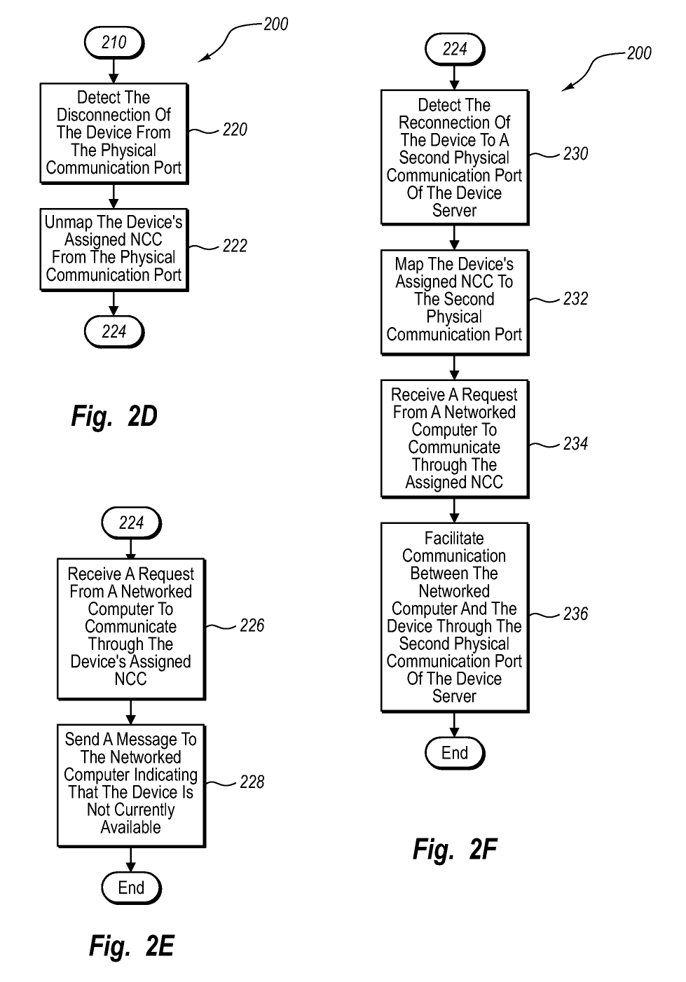

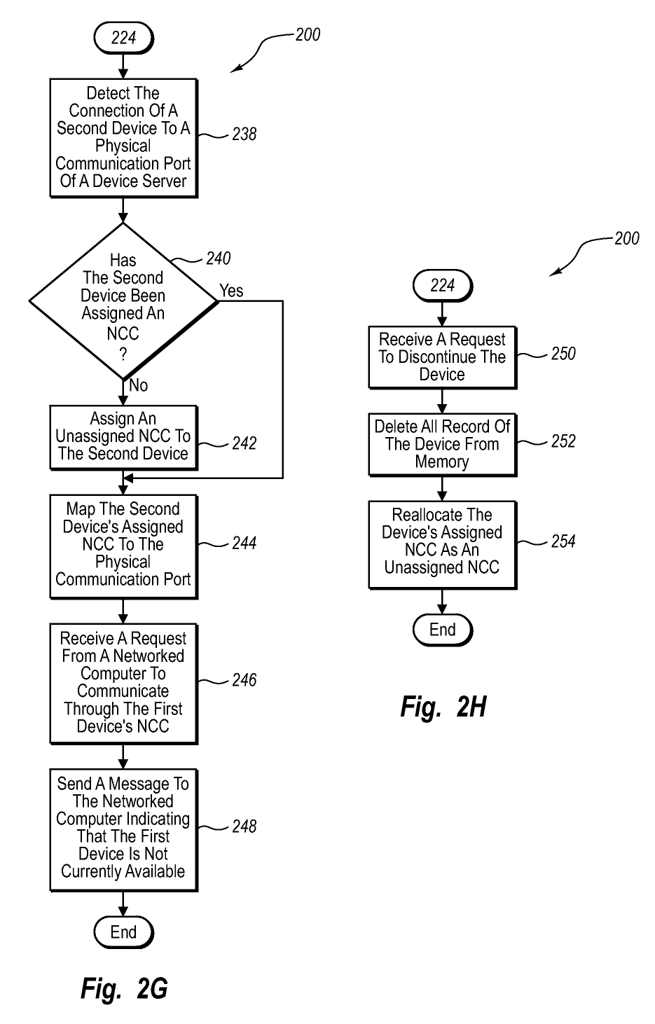

With continued reference to FIGS. 1A and 1B, and now also with reference to FIGS. 2A-2H, example methods for tracking devices that are connected to a physical communication port of a device server are disclosed by way of a series of process steps designated at 200. The method 200 of FIGS. 2A-2H can be implemented in a networked computing environment similar to FIG. 1A. More particularly, the method 200 can be implemented in a network device server similar to the print server 102 disclosed in FIGS. 1A and 1B. The method 200 is particularly suited to implementation in a network device server that is capable of physically attaching to one or more peripheral devices through one or more physical communication ports.

For example, the method 200 can be implemented in the print server 102 of FIGS. 1A and 1B. As disclosed in FIG. 1A and 1B, the print server 102 includes three USB ports 104a-104c, each of which is configured to connect to a USB cable of a peripheral device. The print server is also capable of network communication over the wireless router 112 with the computers 110a-100c.

In the disclosure of the method 200 below, various examples of each of the acts of the method 200 will be given. It is assumed for the purpose of these examples that one or more processors of the print server 102 of FIGS. 1A and 1B is in communication with one or more computer-readable media which carry computer-executable instructions which enable the one or processors to perform each of the acts disclosed in connection with the method 200.

With particular reference now to the disclosure of FIG. 2A, method 200 includes an act 202 of detecting the connection of a device to a physical communication port of a device server. For example, the print server 102 might detect the physical connection of the printer 106a to the USB port 104a. The physical connection can be accomplished using the USB cable 108a attached to the printer 106a. Although the example print server 102 is disclosed as including only USB communication ports, it is contemplated that other types of communication ports are possible including, but not limited to, serial ports, parallel ports, firewire ports, centronix ports, or SCSI ports.

Method 200 also includes an act 204 for determining whether the device has been assigned an NCC. The NCC can be any type of communication addressing scheme, for example, a raw TCP port address. A device server can determine whether the printer 106a has been assigned an NCC by querying a table of IKs of devices that have been assigned NCCs. The table may include the NCC that was assigned to each device at the time that each device was first connected to the device server. If the IK of the device and corresponding assigned NCC is found in the table, the device server can conclude that the device has been assigned a NCC. If, on the other hand, the IK of the device and corresponding assigned NCC is not found in the table, the device server can conclude that the device has not been assigned an NCC.

For example, the print server 102 can query the assigned NCCs table 120 in order to determine whether the printer 106a has been assigned an NCC. If the assigned NCCs table 120 contains a record with the serial number of the printer 106a, then the print server 102 determines that the printer 106a has been assigned an NCC. If, on the other hand, the assigned NCCs table 120 does not include a record having the serial number of the printer 106a, then the print server 102 determines that the printer 106a has not been assigned an NCC.

If the device has not been assigned an NCC, the method 200 proceeds to an act 206 of assigning an unassigned NCC to the device. For example, the network device server 102 can assign the printer 106a an unassigned NCC. This can be accomplished by retrieving and deleting an unassigned NCC from the unassigned NCC table 124 and adding a record containing the serial number of the printer 106a and the retrieved unassigned NCC to the assigned NCCs table 120.

After assigning an unassigned NCC to the device at act 206, or if the device had already been assigned an NCC, the method 200 proceeds to an act 208 of mapping the device's assigned NCC to the physical communication port. For example, the network device server 102 can map the NCC assigned to the printer 106a to the USB port 104a. This mapping can be accomplished by inserting a record into the current connection mappings table 122 containing the physical port number of the USB port 104a and the NCC assigned to the printer 106a

After method 200 arrives at a point 210, one of at least three possible acts can occur. The first possibility, as disclosed in FIG. 2B, is an act 212 of receiving a request from a networked computer for driver installation information corresponding to the device. For example, the print server 102 can receive a request from the PC 110a for driver installation information corresponding to the printer 106a. As used herein, the phrase “driver installation information” is information that a computer needs in order to install a driver corresponding to a particular peripheral device. For example, driver installation information may include the make and model of the peripheral device, or the name or other unique identifier of a driver installation file corresponding to the peripheral device. The driver installation information may also include the NCC that is assigned to communicate with the peripheral device.

The method 200 next proceeds to an act 214 of sending the requested driver installation information to the networked computer. For example, the print server 102 can send the make and model of the printer 106a, as well as the assigned NCC “9100”, to the PC 110a, which enables the PC 110a to install a driver for the printer 106a associated with the NCC, TCP raw port address “9100”. This driver installation will enable the PC 110a to control and communicate with the printer 106a. It is important to note in this context that the acts 202-208 must be performed prior to the acts 212 and 214 in order for the NCC of the device to be assigned and remembered prior to the installation of the device driver on a networked computer.

The second possible act that can occur after arriving at point 210, as disclosed in FIG. 2C, is an act 216 of receiving a request from a networked computer to communicate through the device's assigned NCC. For example, the print server 102 can receive a request from the PC 110a to send a print job through the NCC “9100” that has been assigned to the printer 106a.

The method 200 next proceeds to an act 218 of facilitating communication between the networked computer and the device through the physical communication port. For example, given the request to communicate through the NCC “9100”, the print server 102 can query the current mappings table 122 in order to determine that physical port number “1” is currently mapped to the NCC “9100”. The network device server 102 can then facilitate communication between the PC 110a and the printer 106a through the USB port 104a.

The third possible act that can occur after arriving at point 210, as disclosed in FIG. 2D, is an act 220 of detecting the disconnection of the device from the physical communication port. For example, the print server 102 can detect that the USB cable 108a of the printer 106a has been disconnected from the USB port 104a.

The method 200 then proceeds to an act 222 of unmapping the device's assigned NCC from the physical communication port. For example, the print server 102 can unmap the NCC “9100” that has assigned to the printer 106a from the USB port 104a. This can be accomplished by simply removing the corresponding entry from the current connection mappings table 122.

After the method 200 arrives at the point 224, one of at least four possible acts can occur. The first possibility, disclosed in FIG. 2E, is an act 226 of receiving a request from a networked computer to communicate through the device's assigned NCC. For example, the printer server 102 can receive a request from the laptop PC 110b to send a print job through the port 9100 that has been assigned to the printer 106a. The print server 102 can determine whether this communication is currently possible by querying the current connection mappings table 122. In this example, since the record corresponding to port “9100” was deleted from the current connection mappings table 122 at act 222, the print server 102 will determine that this communication is not currently possible.

The method 200 then proceeds to an act 228 of sending a message to the networked computer indicating that the device is not currently available. For example, the print server 102 can send an error message to the laptop PC 110b indicating that the printer 106a has been disconnected and is not currently available to handle a print job.

The second possible act that can occur after arriving at point 224, as disclosed in FIG. 2F, is an act 230 of detecting the reconnection of the device to a second physical communication port of the device server. For example, the print server 102 can detect the reconnection of the printer 106a to the USB port 104b.

The method 200 next proceeds to an act 232 of mapping the device's assigned NCC to the second physical communication port. For example, the print server 102 can map the NCC “9100” assigned to the printer 106a to the USB port 104b. This mapping can be accomplished by querying the assigned NCCs table 120 to determine the NCC assigned to the printer 106a, and inserting a record into the current communication mappings table 122 that maps the NCC “9100” to physical port number “2” corresponding to the USB port 104b.

The method 200 next includes an act 234 of receiving a request from a networked computer to communicate through the assigned NCC. For example, the print server 102 can receive a request from the PC 110c to send a print job to the printer 106a through the NCC “9100”. The print server 102 can then query the current connection mappings table 122 to determine that the NCC “9100”, is currently mapped to physical port number “2” corresponding to the USB port 104b.

The method 200 then includes an act 236 of facilitating communication between the networked computer and the device through the second physical communication port of the device server. For example, the print server 102 can send the print job that it received from the laptop PC 110b to the printer 106a through the USB port 104b. Act 236 results in seamless communication between the computers 110a-110c and the printer 106a despite the disconnection of the printer 106a from the first USB port 104a and the reconnection of the printer 106a to the second USB port 104b.

The third possible act that can occur after arriving at point 224, as disclosed in FIG. 2G, is an act 238 of detecting the connection of a second device to the physical communication port of the device server. For example, the print server 102 can detect the connection of the scanner 106c to the USB port 104a. After this detection, acts 240 and 244 will be performed. Also, depending on whether the second device has been connected to the device server previously, act 242 may also be performed. Acts 238-344 are substantially similar to acts 202-208 except that the device associated with acts 238-244 is a second device that is distinct from the first device that is associated with the acts 202-208. For example, while the first device associated with acts 202-208 may be the printer 106a, the second device associate with act 238-244 may be the scanner 106c. The acts 238-244 can be accomplished in a manner similar to the acts 202-208 using the tables 120-124.

Method 200 next includes acts 246 and 248, which are substantially similar to the acts 226 and 228. The act 248 results in a notification to the networked computer indicating that the printer 106a that was previously connected to USB port 104a is not currently available. This result is accomplished despite the current connection of the scanner 106c to the USB port 104a. Method 200 is therefore capable of avoiding a device driver mismatch by tracking of which peripheral devices are connected to which physical communication ports at any given moment.

The fourth possible act that can occur after arriving at point 224, as disclosed in FIG. 2H, is an act 250 of receiving a request to discontinue the device. The request can be received from a networked computer or from a user interface of the device server. For example, after the use of the printer 106a has been discontinued, a user may wish to inform the device server that the device will no longer be in use. Therefore, the user may send a request to the device server to discontinue the printer 106a. Alternatively, this request can be automatically generated and received by the device server in response to the lapse of a given amount of time. For example, if the printer 106a has been disconnected from the print server 102 for a set amount of time, for example, one week, the print server 102 or other computing device might automatically generate a request to discontinue the device. Therefore, it is possible that in this context, the print server 102 can “receive” the request from itself, such as from a separate software process running on the print server 102. A second alternative is that the request to discontinue the device is received in response to a “factory default reset” command from a user. In some situations, a user may wish to restore a device server to its original factory settings. When this command is given, the device server may automatically generate and receive a request to discontinue each device that is currently being tracked by the device server.

Method 200 next includes an act 252 of deleting all record of the device from memory. For example, the device server 102 can delete the record in the assigned NCCs table 120 containing the serial number 98892.

Method 200 next includes an act 254 of reallocating the device's assigned NCC as an unassigned NCC. For example, the device server 102 can delete the record in the current connection mappings table 122 containing the NCC “9100”, and insert the NCC “9100” into the unassigned NCC table 124. Acts 250-254 result in the freeing up of unused NCCs. This can be advantageous in a situation where a large number of peripheral devices are being tracked by the device server 102 but only a limited number of NCCs are available for assignment by the device server 102.

The example method 200 enables a network device server to always maintain a match between device drivers loaded on one or more networked computers and a device, whether or not the device is connected, disconnected, or reconnected to a different physical communication port on the network device server. The example method 400 prevents a networked computer from communicating with peripheral devices using mismatched device drivers. The method 200 dynamically reassigns NCCs to physical communication ports as necessary as peripheral devices are connected, disconnected, and reconnected to a network device server. The example method 400 therefore simplifies the software management on networked computers that are configured to access the device over the network through the network device server.

The example method 200 of FIGS. 2A-2H can be implemented using computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. In a networked computing environment including a network device server having at least one physical communication port, a method for tracking devices that are connected to the at least one physical communication port of the device server, the method comprising:
detecting the connection of a device to a physical communication port of a device server;
determining whether the device has been assigned an NCC;
if the device has not been assigned an NCC, assigning an unassigned NCC to the device; and
mapping the device's assigned NCC to the physical communication port.

2. The method as recited in claim 1, wherein determining whether the device has been assigned an NCC comprises:
querying a table of IKs of devices that have been assigned NCCs, where the table includes the NCC that was assigned to each device at the time that each device was first connected to the device server;
if the IK of the device and corresponding NCC is found in the table, concluding that the device has been assigned an NCC; and
if the IK of the device and corresponding NCC is not found in the table, concluding that the device has not been assigned an NCC.

3. The method as recited in claim 1, wherein mapping the device's assigned NCC to the physical communication port comprises:
inserting a record containing an IK of the physical communication port and the device's assigned NCC into a table of current connection mappings.

4. The method as recited in claim 1, further comprising:
receiving a request from a networked computer for driver installation information corresponding to the device; and
sending the requested driver installation information to the networked computer.

5. The method as recited in claim 1, wherein detecting the connection of a device to a physical communication port of a device server comprises detecting the connection of a printer to a physical communication port of a device server.

6. The method as recited in claim 1, wherein detecting the connection of a device to a physical communication port of a device server comprised detecting the connection of the device to one of a USB port, a serial port, a parallel port, a firewire port, a centronix port, or a SCSI port of a device server.

7. The method as recited in claim 1, further comprising:
receiving a request from a networked computer to communicate through the device's assigned NCC; and
facilitating communication between the networked computer and the device through the physical communication port.

8. The method as recited in claim 1, further comprising:
detecting the disconnection of the device from the physical communication port; and
unmapping the device's assigned NCC from the physical communication port.

9. The method as recited in claim 8, further comprising:
receiving a request from a networked computer to communicate through the device's assigned NCC; and
sending a message to the networked computer indicating that the device is not currently available.

10. The method as recited in claim 8, further comprising:
detecting the reconnection of the device to a second physical communication port of the device server; and
mapping the device's assigned NCC to the second physical communication port.

11. The method as recited in claim 10, further comprising:
receiving a request from a networked computer to communicate through the assigned NCC; and
facilitating communication between the networked computer and the device through the second physical communication port of the device server.

12. The method as recited in claim 8, further comprising:
detecting the connection of a second device to the physical communication port of the device server; and
determining whether the second device has been assigned an NCC;
if the second device has not been assigned an NCC,
assigning an unassigned NCC to the second device; and
mapping the second device's assigned NCC to the physical communication port.

13. The method as recited in claim 12, further comprising:
receiving a request from a networked computer to communicate through the first device's NCC; and
sending a message to the networked computer indicating that the first device is not currently available.

14. The method as recited in claim 8, further comprising:
receiving a request to discontinue the device;
deleting all record of the device from memory; and
reallocating the device's assigned NCC as an unassigned NCC.

15. The method as recited in claim 1, wherein determining whether the device has been assigned an NCC comprises determining whether the device has been assigned a raw TCP port address.

16. A computer program product tracking devices that are connected to at least one physical communication port of a device server, the computer program product comprising:
a computer readable medium carrying computer executable instructions for implementing the method, the computer executable instructions, when executed, causing the system to perform the following:
an act of detecting the connection of a device to a physical communication port of a device server;
an act of determining whether the device has been assigned an NCC;
if the device has not been assigned an NCC, an act of assigning an unassigned NCC to the device; and
an act of mapping the device's assigned NCC to the physical communication port.

17. The computer program product as recited in claim 16, wherein the computer readable medium further carries computer executable instructions for performing the following:
an act of detecting the disconnection of the device from the physical communication port; and
an act of unmapping the device's assigned NCC from the physical communication port.

18. The computer program product as recited in claim 17, wherein the computer readable medium further carries computer executable instructions for performing the following:
an act of detecting the reconnection of the device to a second physical communication port of the device server;
an act of mapping the device's assigned NCC to the second physical communication port;
an act of receiving a request from a networked computer to communicate through the assigned NCC; and
an act of facilitating communication between the networked computer and the device through the second physical communication port of the device server.

19. The computer program product as recited in claim 17, wherein the computer readable medium further carries computer executable instructions for performing the following:
an act of detecting the connection of a second device to the physical communication port of the device server; and
an act of determining whether the second device has been assigned an NCC;
if the second device has not been assigned an NCC, an act of assigning an unassigned NCC to the second device;
an act of mapping the second device's assigned NCC to the physical communication port;
and act of receiving a request from a networked computer to communicate through the first device's NCC; and
an act of sending a message to the networked computer indicating that the first device is not currently available.

20. The computer program product as recited in claim 17, wherein the computer readable medium further carries computer executable instructions for performing the following:
an act of receiving a request to discontinue the device;
an act of deleting all record of the device from memory; and
an act of reallocating the device's assigned NCC as an unassigned NCC.
